(19) United States
(12) Patent Application Publication
(10) Pub. No.: US 2026/0213813 A1
(43) Pub. Date: Jul. 23, 2026

(54) METHOD AND APPARATUS FOR CHANNEL STATE INFORMATION FEEDBACK BASED ON ARTIFICIAL INTELLIGENCE AND MACHINE LEARNING

(71) Applicant: Electronics and Telecommunications Research Institute, Daejeon (KR)

(72) Inventors: Anseok LEE, Daejeon (KR); Yong Jin KWON, Daejeon (KR); Seungjae BAHNG, Daejeon (KR); Youngjoon YOON, Daejeon (KR); Heesoo LEE, Daejeon (KR); Yo-Seb JEON, Pohang-Si (KR); Junyong SHIN, Pohang-Si (KR); Jinsung PARK, Pohang-Si (KR)

(73) Assignee: Electronics and Telecommunications Research Institute, Daejeon (KR)

(21) Appl. No.: 19/428,715

(22) Filed: Dec. 22, 2025

(30) Foreign Application Priority Data
Dec. 23, 2024 (KR) 10-2024-0193845
Dec. 18, 2025 (KR) 10-2025-0202836

(51) Int. Cl. H04B 7/06

(52) U.S. Cl. CPC H04B 7/0626; H04B 7/0639

(57) ABSTRACT

A method of a terminal may comprise: generating channel state information (CSI) based on at least one channel state information-reference signal (CSI-RS) received from a base station; compressing the CSI using a machine learning-based CSI encoder to generate a latent vector; quantizing the latent vector based on at least one codebook to output a codeword index set; entropy-coding the codeword index set to generate a variable-length bitstream; and transmitting, to the base station, a CSI feedback including the variable-length bitstream.

### CROSS-REFERENCE TO RELATED APPLICATIONS

This application claims priority to Korean Patent Applications No. 10-2024-0193845, filed on Dec. 23, 2024, and No. 10-2025-0202836, filed on Dec. 18, 2025, with the Korean Intellectual Property Office (KIPO), the entire contents of which are hereby incorporated by reference.

### BACKGROUND

### 1. Technical Field

The present disclosure relates to an artificial intelligence/machine learning (AI/ML) technique for communication networks, and more particularly, to a method and apparatus for AI/ML-based channel state information (CSI) feedback that increase CSI feedback efficiency based on AI/ML technologies.

### 2. Related Art

With the development of information and communication technology, various wireless communication technologies have been developed. Typical wireless communication technologies include long term evolution (LTE) and new radio (NR), which are defined in the 3rd generation partnership project (3GPP) standards. The LTE may be one of 4th generation (4G) wireless communication technologies, and the NR may be one of 5th generation (5G) wireless communication technologies.

For the processing of rapidly increasing wireless data after the commercialization of the 4th generation (4G) communication system (e.g. Long Term Evolution (LTE) communication system or LTE-Advanced (LTE-A) communication system), the 5th generation (5G) communication system (e.g. new radio (NR) communication system) that uses a frequency band (e.g. a frequency band of 6 GHz or above) higher than that of the 4G communication system as well as a frequency band of the 4G communication system (e.g. a frequency band of 6 GHz or below) is being considered. The 5G communication system may support enhanced Mobile BroadBand (eMBB), Ultra-Reliable and Low-Latency Communication (URLLC), and massive Machine Type Communication (mMTC).

In a communication system, a transmitter (e.g. base station) may obtain a channel state for a wireless channel between the transmitter and a receiver (e.g. terminal) for data transmission to the receiver. The transmitter may transmit a channel state information-reference signal (CSI-RS) to the receiver, and the receiver may generate channel state information (CSI) based on the CSI-RS and transmit the CSI to the transmitter. The transmitter may obtain the channel state based on the received CSI, and the CSI may include information for scheduling by the transmitter (e.g. rank indicator (RI), channel quality indicator (CQI), or precoding information).

Discussions on utilizing artificial intelligence/machine learning (AI/ML) technology in communication systems have recently been actively conducted. The AI/ML technology may be utilized in fields such as CSI feedback enhancement in the communication system, and for example, the receiver may transmit CSI to the transmitter using an autoencoder (AE)-based neural network model. However, in an existing CSI feedback method based on AI/ML technology, the receiver may need to transmit a large amount of CSI to the transmitter, and thus radio resource occupancy and overhead due to CSI feedback may increase, and this may degrade performance of the communication system. Accordingly, methods capable of reducing overhead for CSI feedback of the receiver are required.

### SUMMARY

The present disclosure for resolving the above-described problems is directed to providing a method and apparatus for AI/ML-based CSI feedback that support efficient compression and feedback of CSI.

According to a first exemplary embodiment of the present disclosure, a method of a terminal may comprise: generating channel state information (CSI) based on at least one channel state information-reference signal (CSI-RS) received from a base station; compressing the CSI using a machine learning-based CSI encoder to generate a latent vector; quantizing the latent vector based on at least one codebook to output a codeword index set; entropy-coding the codeword index set to generate a variable-length bitstream; and transmitting, to the base station, a CSI feedback including the variable-length bitstream.

The quantizing of the latent vector may comprise: dividing the latent vector into a plurality of sub-vectors; mapping each of the plurality of sub-vectors to one of a plurality of codewords of the at least one codebook; and rearranging the mapped codewords to output the codeword index set.

The mapping of each of the plurality of sub-vectors to one of the plurality of codewords may comprise: selecting codewords respectively corresponding to the plurality of sub-vectors based on at least one of a minimum Euclidean distance between each of the plurality of sub-vectors and the plurality of codewords or a prior probability distribution of each of the plurality of codewords; and mapping the plurality of sub-vectors to the selected codewords, respectively.

The method may further comprise: adjusting a bit length of the variable-length bitstream based on a preset maximum bit budget.

The adjusting of the bit length of the variable-length bitstream may comprise: in response to determining that the bit length of the variable-length bitstream exceeds the preset maximum bit budget, performing bit clipping to replace at least one index having a largest bit length among a plurality of indexes included in the codeword index set with another index having a smaller bit length; and entropy-coding a codeword index set reconstructed based on the bit clipping.

The adjusting of the bit length of the variable-length bitstream may further comprise: setting a bit margin; and in response to determining that the bit length of the variable-length bitstream is greater than or equal to the preset maximum bit budget and less than or equal to a sum of the preset maximum bit budget and the bit margin, determining to perform the bit clipping.

The adjusting of the bit length of the variable-length bitstream may further comprise: in response to determining that the bit length of the variable-length bitstream is less than the preset maximum bit budget or exceeds the sum of the preset maximum bit budget and the bit margin, determining not to perform the bit clipping.

The quantizing of the latent vector may comprise: determining a total bit requirement of each of a plurality of codebooks; selecting, from among some of the plurality of codebooks whose total bit requirements are less than or equal to a maximum bit budget, a codebook having a smallest bit requirement; and quantizing the latent vector based on the selected codebook.

The quantizing of the latent vector may comprise: selecting a codebook having a smallest bit requirement among a plurality of codebooks, based on a total bit requirement of each of the plurality of codebooks exceeding a maximum bit budget; quantizing the latent vector based on the selected codebook to output the codeword index set; and performing bit clipping such that a bit length of the variable-length bitstream generated based on the codeword index set satisfies the maximum bit budget

According to a second exemplary embodiment of the present disclosure, a method of a base station may comprise: transmitting, to a terminal, at least one channel state information-reference signal (CSI-RS); receiving, from the terminal, a CSI feedback including a bitstream generated based on the CSI-RS; entropy-decoding the bitstream using a machine learning-based CSI decoder to restore a codeword index set; dequantizing the codeword index set based on at least one codebook; reconstructing a latent vector based on the dequantized codeword index set; and restoring CSI from the reconstructed latent vector.

The dequantizing of the codeword index set may comprise: obtaining, from among a plurality of codewords of each of the at least one codebook, codewords corresponding to a plurality of indexes included in the codeword index set; and rearranging the obtained codewords to generate the latent vector.

According to a third exemplary embodiment of the present disclosure, a terminal may comprise at least one processor, and the at least one processor may cause the terminal to perform: generating channel state information (CSI) based on at least one channel state information-reference signal (CSI-RS) received from abase station; compressing the CSI using a machine learning-based CSI encoder to generate a latent vector; quantizing the latent vector based on at least one codebook to output a codeword index set; entropy-coding the codeword index set to generate a variable-length bitstream; and transmitting, to the base station, a CSI feedback including the variable-length bitstream.

In the quantizing of the latent vector, the at least one processor may further cause the terminal to perform: dividing the latent vector into a plurality of sub-vectors; mapping each of the plurality of sub-vectors to one of a plurality of codewords of the at least one codebook; and rearranging the mapped codewords to output the codeword index set.

In the mapping of each of the plurality of sub-vectors to one of the plurality of codewords, the at least one processor may further cause the terminal to perform: selecting codewords respectively corresponding to the plurality of sub-vectors based on at least one of a minimum Euclidean distance between each of the plurality of sub-vectors and the plurality of codewords or a prior probability distribution of each of the plurality of codewords; and mapping the plurality of sub-vectors to the selected codewords, respectively.

The at least one processor may further cause the terminal to perform: adjusting a bit length of the variable-length bitstream based on a preset maximum bit budget.

In the adjusting of the bit length of the variable-length bitstream, the at least one processor may further cause the terminal to perform: in response to determining that the bit length of the variable-length bitstream exceeds the preset maximum bit budget, performing bit clipping to replace at least one index having a largest bit length among a plurality of indexes included in the codeword index set with another index having a smaller bit length; and entropy-coding a codeword index set reconstructed based on the bit clipping.

In the adjusting of the bit length of the variable-length bitstream, the at least one processor may further cause the terminal to perform: setting a bit margin; and in response to determining that the bit length of the variable-length bitstream is greater than or equal to the preset maximum bit budget and less than or equal to a sum of the preset maximum bit budget and the bit margin, determining to perform the bit clipping.

In the adjusting of the bit length of the variable-length bitstream, the at least one processor may further cause the terminal to perform: in response to determining that the bit length of the variable-length bitstream is less than the preset maximum bit budget or exceeds the sum of the preset maximum bit budget and the bit margin, determining not to perform the bit clipping.

In the quantizing of the latent vector, the at least one processor may further cause the terminal to perform: determining a total bit requirement of each of a plurality of codebooks; selecting, from among some of the plurality of codebooks whose total bit requirements are less than or equal to a maximum bit budget, a codebook having a smallest bit requirement; and quantizing the latent vector based on the selected codebook.

In the quantizing of the latent vector, the at least one processor may further cause the terminal to perform: selecting a codebook having a smallest bit requirement among a plurality of codebooks, based on a total bit requirement of each of the plurality of codebooks exceeding a maximum bit budget; quantizing the latent vector based on the selected codebook to output the codeword index set; and performing bit clipping such that a bit length of the variable-length bitstream generated based on the codeword index set satisfies the maximum bit budget.

According to the present disclosure, a terminal may adjust a bit length of a variable-length bitstream corresponding to channel state information generated through an autoencoder so as to satisfy a maximum bit budget, and may transmit a CSI feedback to a base station based on the adjusted bitstream. Accordingly, the terminal can reduce a bit overhead of the CSI feedback and can prevent information loss of the CSI feedback, thereby enabling accurate CSI reconstruction and improving efficiency and reliability of the CSI feedback.

### BRIEF DESCRIPTION OF DRAWINGS

FIG. 1 is a conceptual diagram illustrating exemplary embodiments of a communication system.

FIG. 2 is a block diagram illustrating exemplary embodiments of a communication node constituting a communication system.

FIG. 3 is a sequence diagram illustrating an exemplary embodiment of a method for channel state information feedback of a terminal in a communication network.

FIG. 4 is a conceptual diagram illustrating an exemplary embodiment of an autoencoder for channel state information feedback by a terminal.

FIG. 5 is a conceptual diagram illustrating an exemplary embodiment of an autoencoder for channel state information feedback by a terminal.

FIG. 6 is a conceptual diagram illustrating an exemplary embodiment of an autoencoder for channel state information feedback by a terminal.

FIG. 7 is a conceptual diagram illustrating an exemplary embodiment of a training method for an autoencoder.

FIG. 8 is a conceptual diagram illustrating an exemplary embodiment of a method for setting a vector quantization criterion for training an autoencoder.

FIG. 9 is a conceptual diagram illustrating an exemplary embodiment of a method for setting a vector quantization criterion for training an autoencoder.

FIG. 10 is a conceptual diagram illustrating an exemplary embodiment of a method for applying a maximum feedback bit budget constraint of an autoencoder.

FIG. 11 is a conceptual diagram illustrating an exemplary embodiment of an algorithm for a maximum feedback bit budget constraint.

FIG. 12 is a conceptual diagram illustrating an exemplary embodiment of a method for satisfying a maximum feedback bit budget constraint of an autoencoder.

FIG. 13 is a conceptual diagram illustrating an exemplary embodiment of an algorithm for training and inference operations for satisfying a maximum feedback bit budget constraint of an autoencoder.

FIG. 14 is a graph showing performance of a CSI feedback function of a terminal in an indoor environment.

FIG. 15 is a graph showing performance of a CSI feedback function of a terminal in an outdoor environment.

### DETAILED DESCRIPTION OF THE EMBODIMENTS

Exemplary embodiments of the present disclosure are disclosed herein. However, specific structural and functional details disclosed herein are merely representative for purposes of describing embodiments of the present disclosure. Thus, embodiments of the present disclosure may be embodied in many alternate forms and should not be construed as limited to embodiments of the present disclosure set forth herein.

Accordingly, while the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

A communication network to which exemplary embodiments according to the present disclosure are applied will be described. The communication network may be a non-terrestrial network (NTN), a 4G communication network (e.g. Long-Term Evolution (LTE) communication network), a 5G communication network (e.g. New Radio (NR) communication network), or a B5G mobile communication network (e.g. 6G mobile communication network). The 4G communication network and the 5G communication network may be classified as terrestrial networks.

In exemplary embodiments, “an operation (e.g. transmission operation) is configured” may mean that “configuration information (e.g. information element(s) or parameter(s)) for the operation and/or information indicating to perform the operation is signaled”. “Information element(s) (e.g. parameter(s)) are configured” may mean that “corresponding information element(s) are signaled”. The signaling may be at least one of system information (SI) signaling (e.g. transmission of system information block (SIB) and/or master information block (MIB)), RRC signaling (e.g. transmission of RRC parameters and/or higher layer parameters), MAC control element (CE) signaling, or PHY signaling (e.g. transmission of downlink control information (DCI), uplink control information (UCI), and/or sidelink control information (SCI)).

In the present disclosure, even when a method (e.g. transmission or reception of a signal) performed at a first communication node among communication nodes is described, a corresponding second communication node may perform a method (e.g. reception or transmission of the signal) corresponding to the method performed at the first communication node. That is, when an operation of a terminal is described, a base station corresponding to the terminal may perform an operation corresponding to the operation of the terminal. Conversely, when an operation of a base station is described, a terminal corresponding to the base station may perform an operation corresponding to the operation of the base station. In addition, when an operation of a first terminal is described, a second terminal corresponding to the first terminal may perform an operation corresponding to the operation of the first terminal. Conversely, when an operation of a second terminal is described, a first terminal corresponding to the second terminal may perform an operation corresponding to the operation of the second terminal.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

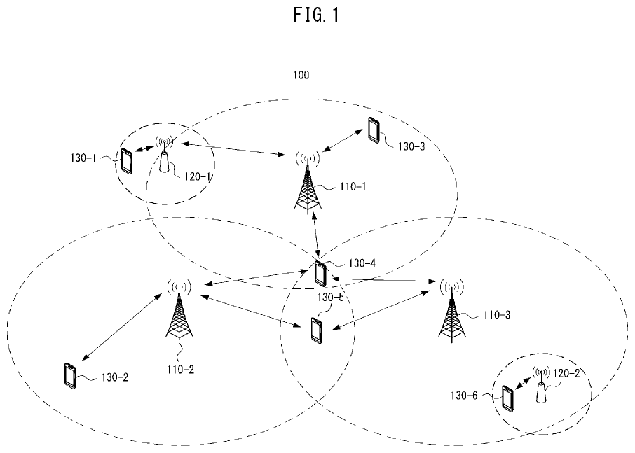

FIG. 1 is a conceptual diagram illustrating exemplary embodiments of a communication system.

Referring to FIG. 1, a communication system 100 may comprise a plurality of communication nodes 110-1, 110-2, 110-3, 120-1, 120-2, 130-1, 130-2, 130-3, 130-4, 130-5, and 130-6. The plurality of communication nodes 110-1, 110-2, 110-3, 120-1, 120-2, 130-1, 130-2, 130-3, 130-4, 130-5, and 130-6 may include a plurality of base stations 110-1, 110-2, 110-3, 120-1, and 120-2) and a plurality of terminals, for example, a plurality of user terminals 130-1, 130-2, 130-3, 130-4, 130-5, and 130-6.

Each of the plurality of communication nodes 110-1, 110-2, 110-3, 120-1, 120-2, 130-1, 130-2, 130-3, 130-4, 130-5, and 130-6 may support 4G communication (e.g. long term evolution (LTE), LTE-advanced (LTE-A)), 5G communication (e.g. new radio (NR)), 6G communication, etc. specified in the 3rd generation partnership project (3GPP) standards. The 4G communication may be performed in frequency bands below 6 GHz, and the 5G and 6G communication may be performed in frequency bands above 6 GHz as well as frequency bands below 6 GHz.

For example, in order to perform the 4G communication, 5G communication, and 6G communication, the plurality of communication may support a code division multiple access (CDMA) based communication protocol, wideband CDMA (WCDMA) based communication protocol, time division multiple access (TDMA) based communication protocol, frequency division multiple access (FDMA) based communication protocol, orthogonal frequency division multiplexing (OFDM) based communication protocol, filtered OFDM based communication protocol, cyclic prefix OFDM (CP-OFDM) based communication protocol, discrete Fourier transform spread OFDM (DFT-s-OFDM) based communication protocol, orthogonal frequency division multiple access (OFDMA) based communication protocol, single carrier FDMA (SC-FDMA) based communication protocol, non-orthogonal multiple access (NOMA) based communication protocol, generalized frequency division multiplexing (GFDM) based communication protocol, filter bank multi-carrier (FBMC) based communication protocol, universal filtered multi-carrier (UFMC) based communication protocol, space division multiple access (SDMA) based communication protocol, orthogonal time-frequency space (OTFS) based communication protocol, or the like.

Further, the communication system 100 may further include a core network (not shown). When the communication 100 supports 4G communication, the core network may include a serving gateway (S-GW), packet data network (PDN) gateway (P-GW), mobility management entity (MME), and the like. When the communication system 100 supports 5G communication or 6G communication, the core network may include a user plane function (UPF), session management function (SMF), access and mobility management function (AMF), and the like.

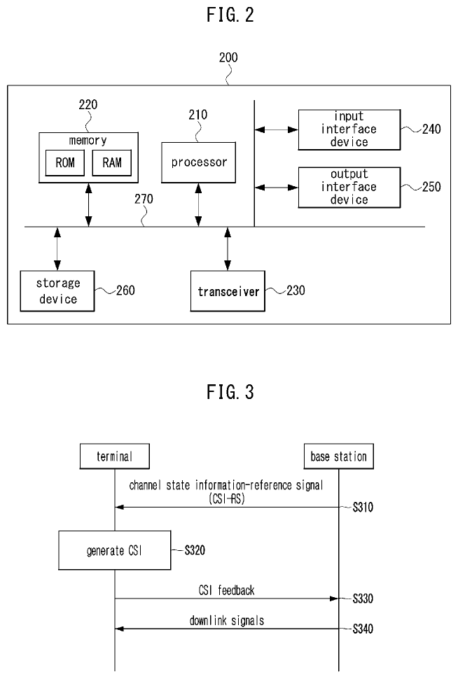

FIG. 2 is a block diagram illustrating exemplary embodiments of a communication node constituting a communication system.

Referring to FIG. 2, a communication node 200 may comprise at least one processor 210, a memory 220, and a transceiver 230 connected to the network for performing communications. Also, the communication node 200 may further comprise an input interface device 240, an output interface device 250, a storage device 260, and the like. Each component included in the communication node 200 may communicate with each other as connected through a bus 270.

However, each component included in the communication node 200 may not be connected to the common bus 270 but may be connected to the processor 210 via an individual interface or a separate bus. For example, the processor 210 may be connected to at least one of the memory 220, the transceiver 230, the input interface device 240, the output interface device 250 and the storage device 260 via a dedicated interface.

The processor 210 may execute a program stored in at least one of the memory 220 and the storage device 260. The processor 210 may refer to a central processing unit (CPU), a graphics processing unit (GPU), or a dedicated processor on which methods in accordance with embodiments of the present disclosure are performed.

Each of the memory 220 and the storage device 260 may be constituted by at least one of a volatile storage medium and a non-volatile storage medium. For example, the memory 220 may comprise at least one of read-only memory (ROM) and random access memory (RAM).

The communication node 200 may include an intelligent model (e.g. AI/ML model) for performing an intelligent function based on AI/ML. The AI/ML model may be classified into a one-sided model and a two-sided model. The one-sided model may be a type in which one of a base station and a terminal among a plurality of communication nodes includes an AI/ML model. The two-sided model may be a type in which each of a base station and a terminal among a plurality of communication nodes includes an AI/ML model.

The communication node 200 may perform life cycle management (LCM) for an AI/ML model, such as for intelligent functionality, model creation, or model maintenance. The LCM may include detailed stages such as data collection, model training, model inference, model deployment, model activation, model deactivation, model selection, model switching, model fallback, and model monitoring.

The communication node 200 may identify an intelligent functionality supported by the communication network 100, or may identify an AI/NL model performing an intelligent functionality. For example, the base station may identify an intelligent functionality or AI/ML model supported by the terminal, and the base station may instruct the terminal to perform activation of a specific intelligent functionality or AI/ML model based on the identified intelligent functionality or AI/ML model.

The communication node 200 may perform LCM for an AI/ML model based on intelligent functionality identification or AI/ML model identification. For example, the communication node 200 may perform functionality-based LCM for the AI/ML model, or the communication node 200 may perform model ID-based LCM for the AI/ML model. The functionality-based LCM may be a process in which the base station and the terminal share functionality information for an intelligent functionality in advance and identify and manage the intelligent functionality based on the shared functionality information. The model ID-based LCM may be a process in which the base station and the terminal share model information together with a model ID in advance and identify and manage an AI/ML model based on the shared model information and the model ID.

As described above, the communication network 100 may perform a specific intelligent functionality based on an intelligent technology using an AI/ML model included in at least one among the plurality of communication nodes 110-1, 110-2, 110-3, 120-1, 120-2, 130-1, 130-2, 130-3, 130-4, 130-5, and 130-6. The specific intelligent functionality may be a channel information feedback enhancement functionality, and at least one among the plurality of communication nodes 110-1, 110-2, 110-3, 120-1, 120-2, 130-1, 130-2, 130-3, 130-4, 130-5, and 130-6 of the communication network 100 may perform the channel information feedback enhancement functionality using an AI/ML model (e.g. autoencoder (AE)).

FIG. 3 is a sequence diagram illustrating an exemplary embodiment of a method for channel state information feedback of a terminal in a communication network.

Referring to FIG. 3, a communication network may include a terminal and a base station. At least one of the terminal or the base station may include an AI/ML model (e.g. autoencoder) for an intelligent channel information feedback enhancement functionality.

The base station may transmit at least one CSI-RS to the terminal to measure a wireless channel state with the terminal (S310).

The terminal may receive at least one CSI-RS from the base station and may measure the received CSI-RS. The terminal may generate CSI based on a CSI-RS measurement result (S320). The CSI may include information such as channel quality indication (CQI), precoding matrix indication (PMI), or rank indication (RI) for a channel between the base station and the terminal.

The terminal may compress the CSI using an autoencoder and may convert the compressed CSI into a coded form (e.g. a bitstream), and may feedback or report the coded form to the base station (S330). The base station may receive the CSI feedback from the terminal and may restore the CSI in the code form using an autoencoder to reconstruct the CSI. Here, the autoencoder included in the terminal and the autoencoder included in the base station may belong to an identical model. For example, the autoencoder may include an encoder block capable of compressing CSI and a decoder block capable of restoring the compressed CSI. The terminal may include the encoder block of the autoencoder, and the base station may include the decoder block of the autoencoder. The base station may transmit a downlink signal for data communication to the terminal based on the reconstructed CSI (S340).

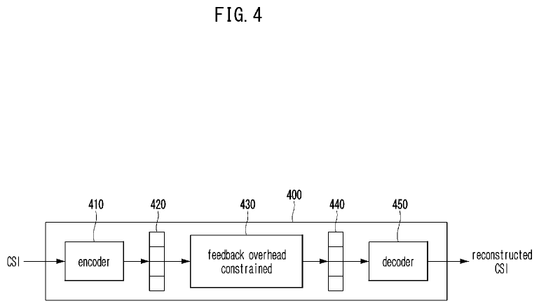

FIG. 4 is a conceptual diagram illustrating an exemplary embodiment of an autoencoder for channel state information feedback by a terminal.

Referring to FIG. 4, an autoencoder 400 may include an encoder block 410, an encoder latent space 420, a feedback overhead constraint block 430, a decoder latent space 440, and a decoder block 450.

The encoder latent space 420 and the decoder latent space 440 may have the same dimension or structure. The encoder latent space 420 may be an output space of the encoder block 410 and may be included in the encoder block 410. The decoder latent space 440 may be an input space of the decoder block 450 and may be included in the decoder block 450.

The autoencoder 400 may be included in each of the terminal and the base station as an identical model. The terminal may utilize functions of the encoder block 410 and the encoder latent space 420 among components of the autoencoder 400, and the base station may utilize functions of the decoder block 450 and the decoder latent space 440 among components of the autoencoder 400. In addition, each of the terminal and the base station may utilize different functions of the feedback overhead constraint block 430.

The encoder block 410 may receive CSI from the terminal and may compress the received CSI into a low-dimensional latent vector and may output the low-dimensional latent vector through the encoder latent space 420.

The CSI may be represented as a channel matrix in the spatial frequency domain, and the terminal may convert the channel matrix into a channel matrix in the angle/delay domain by applying a discrete Fourier transform (DFT) to the channel matrix. The channel matrix in the angle/delay domain may be expressed as Equation 1 below.

$${H}_{ad} = {F}_{d} {H}_{sf} {F}_{a}^{H} \qquad [ Equation 1 ]$$

$${H}_{sf} ∈ {ℂ}^{{N}_{c} \times {N}_{t}}$$

Here, F_{d} may be a DFT matrix for the delay domain, H_{sf} may be a spatial frequency domain channel matrix, Fₐ may be a DFT matrix for the angle domain, N_{c} may be a number of subcarriers, and Nₜ may be a number of transmit antennas.

The channel matrix in the angle/delay domain may include high-dimensional information. The encoder block 410 may compress the channel matrix in the angle/delay domain into a low-dimensional latent vector and may output the low-dimensional latent vector. The latent vector output from the encoder block 410 may be expressed as Equation 2 below.

$$z = {f}_{enc} ( {\tilde{H}}_{ad} ) \qquad [ Equation 2 ]$$

Here, f_{enc} may be an encoder function, and H_{ad} may be the channel matrix in the angle/delay domain.

The feedback overhead constraint block 430 may limit an amount of information of CSI feedback transmitted from the terminal to the base station. For example, the encoder block 410 may output an M×1 latent vector including M sub-vectors (e.g. vector elements). The feedback overhead constraint block 430 may select n sub-vectors determined as valid data among the M sub-vectors of the latent vector output from the encoder block 410 based on a preset overhead constraint value. The feedback overhead constraint block 430 may discard remaining (M−n) sub-vectors that are not selected. In addition, the feedback overhead constraint block 430 may reconstruct the M sub-vectors based on the selected n sub-vectors. The feedback overhead constraint block 430 may perform zero-padding on the (M−n) sub-vectors and may reconstruct an M×1 latent vector including the previously selected n sub-vectors and the zero-padded (M−n) sub-vectors.

As described above, each of the terminal and the base station may utilize different functions of the feedback overhead constraint block 430. For example, the terminal may utilize a function for selecting a predetermined number of sub-vectors from a latent vector among functions of the feedback overhead constraint block 430. The base station may utilize a function for reconstructing a latent vector among the functions of the feedback overhead constraint block 430. Accordingly, the terminal may transmit CSI feedback to the base station based on sub-vectors of the latent vector selected through the feedback overhead constraint block 430. In addition, the base station may restore and reconstruct CSI based on a reconstructed latent vector through the feedback overhead constraint block 430 for CSI feedback received from the terminal.

The decoder block 450 may receive the reconstructed latent vector output by the feedback overhead constraint block 430 through the decoder latent space 440. The decoder block 450 may restore and reconstruct CSI based on the reconstructed latent vector. The decoder block 450 may output the reconstructed CSI.

A scalar quantization (SQ) method for CSI feedback may be applied to the autoencoder 400 illustrated in FIG. 4. For example, the terminal may perform independent scalar quantization on each of n sub-vectors of the latent vector output from the feedback overhead constraint block 430 and may transmit the result to the base station. The independent scalar quantization does not exploit a correlation between different latent elements, that is, a correlation between n sub-vectors, and thus it may be difficult to reduce quantization errors. In addition, the scalar-based independent quantization may require at least one bit for quantization of each of the n sub-vectors, and this may limit the dimension of the latent vector and may degrade CSI feedback performance. Accordingly, a method for improving CSI feedback performance may be required.

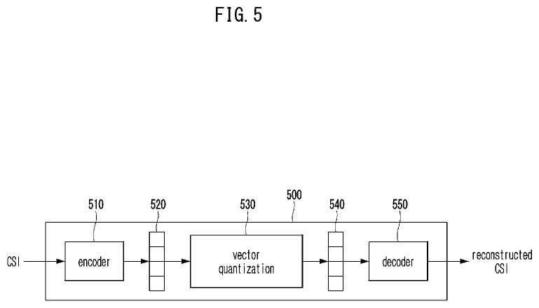

FIG. 5 is a conceptual diagram illustrating an exemplary embodiment of an autoencoder for channel state information feedback by a terminal.

Referring to FIG. 5, an autoencoder 500 may include an encoder block 510, an encoder latent space 520, a vector quantization (VQ) block 530, a decoder latent space 540, and a decoder block 550. The autoencoder 500 illustrated in FIG. 5 may be a vector quantized-variational autoencoder (VQ-VAE).

The encoder latent space 520 and the decoder latent space 540 may have the same dimension or structure. The encoder latent space 520 may be an output space of the encoder block 510 and may be included in the encoder block 510. The decoder latent space 540 may be an input space of the decoder block 550 and may be included in the decoder block 550.

The autoencoder 500 may be included in each of the terminal and the base station as the same model. The terminal may utilize functions of the encoder block 510 and the encoder latent space 520 among components of the autoencoder 500, and the base station may utilize functions of the decoder block 550 and the decoder latent space 540 among components of the autoencoder 500. In addition, each of the terminal and the base station may utilize different functions of the vector quantization block 530. For example, the terminal may utilize a quantization function of the vector quantization block 530, and the base station may utilize a dequantization function of the vector quantization block 530.

The encoder block 510 may compress CSI measured by the terminal into a low-dimensional latent vector and may output the low-dimensional latent vector. The terminal may convert CSI into a channel matrix in the angle/delay domain and may transmit the channel matrix to the encoder block 510. The encoder block 510 may compress the received channel matrix and may output an Mx 1 latent vector including M sub-vectors. The encoder block 510 may have a configuration identical to the encoder block 410 described with reference to FIG. 4.

The vector quantization block 530 may quantize the latent vector output from the encoder block 510. In addition, the vector quantization block 530 may dequantize the quantized latent vector. The vector quantization block 530 may include at least one codebook generated through training for quantization of the latent vector or dequantization of the quantized latent vector, and each of the at least one codebook may include a plurality of codewords.

The vector quantization block 530 may map each of M sub-vectors of the latent vector to a codeword based on the codebook and may rearrange the mapped codewords according to the order of the sub-vectors to generate a quantized latent vector. The vector quantization block 530 may output a codeword index (i.e. codeword index set) corresponding to the quantized latent vector. The codeword index may be a set of index values of respective codewords of the quantized latent vector, and each index value may be an integer. In addition, the vector quantization block 530 may dequantize the codeword index based on the codebook. The vector quantization block 530 may restore sub-vectors of the latent vector based on the dequantized codeword index. The vector quantization block 530 may reconstruct the latent vector based on restored sub-vectors.

According to an exemplary embodiment, the vector quantization block 530 may decompose the latent vector output from the encoder block 510 into a direction component and a magnitude component. The direction component of the latent vector may be in vector form, and the magnitude component may be in scalar form. The vector quantization block 530 may quantize the direction component of the latent vector using the aforementioned codebook. The vector quantization block 530 may quantize the magnitude component of the latent vector using a scalar quantization method. The vector quantization block 530 may synthesize the quantized direction component and the quantized magnitude component and may output a codeword index corresponding to a synthesized result.

The decoder block 550 may receive the reconstructed latent vector from the vector quantization block 530. The decoder block 550 may reconstruct CSI based on the reconstructed latent vector. The decoder block 550 may output the reconstructed CSI.

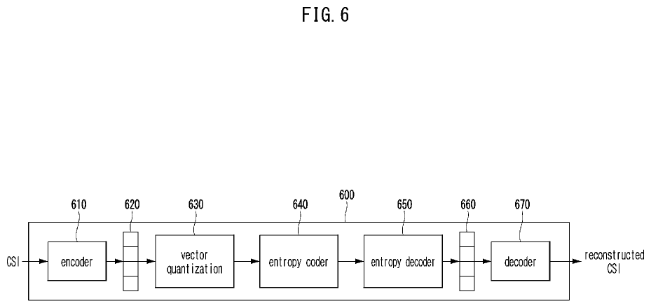

FIG. 6 is a conceptual diagram illustrating an exemplary embodiment of an autoencoder for channel state information feedback by a terminal.

Referring to FIG. 6, an autoencoder 600 may include an encoder block 610, an encoder latent space 620, a vector quantization block 630, an entropy coder block 640, an entropy decoder block 650, a decoder latent space 660, and a decoder block 670. The autoencoder 600 illustrated in FIG. 6 may be an entropy constrained vector quantized-variational autoencoder (ECVQ-VAE).

The encoder latent space 620 and the decoder latent space 660 may have the same dimension or structure. The encoder latent space 620 may be an output space of the encoder block 610 and may be included in the encoder block 610. The decoder latent space 660 may be an input space of the decoder block 670 and may be included in the decoder block 670.

The autoencoder 600 may be included in each of the terminal and the base station as the same model. The terminal may utilize functions of the encoder block 610 and the entropy coder block 640 among components of the autoencoder 600, and the base station may utilize functions of the entropy decoder block 650 and the decoder block 670 among components of the autoencoder 600. In addition, each of the terminal and the base station may utilize different functions of the vector quantization block 630. For example, the terminal may utilize a quantization function of the vector quantization block 630, and the base station may utilize a dequantization function of the vector quantization block 630.

The encoder block 610 may compress CSI measured by the terminal into a low-dimensional latent vector and may output the low-dimensional latent vector. The terminal may convert CSI into a channel matrix in the angle/delay domain and may transmit the channel matrix to the encoder block 610. The encoder block 610 may compress the received channel matrix and may output an Mx 1 latent vector including M sub-vectors. The encoder block 610 may have a configuration identical to the encoder block 410 of FIG. 4.

The vector quantization block 630 may quantize the latent vector output from the encoder block 610. In addition, the vector quantization block 630 may dequantize the quantized latent vector. The vector quantization block 630 may include at least one codebook trained for vector quantization of the latent vector or dequantization of the quantized latent vector, and each of the at least one codebook may include a plurality of codewords.

The vector quantization block 630 may map each of M sub-vectors of the latent vector to a codeword based on the codebook and may rearrange the mapped codewords according to the order of the sub-vectors to generate a quantized latent vector. The vector quantization block 630 may output a codeword index (i.e. codeword index set) for the quantized latent vector. The codeword index may be a set of index values of respective codewords of the quantized latent vector, and each index value may be an integer. In addition, the vector quantization block 630 may dequantize the codeword index based on the codebook. The vector quantization block 630 may reconstruct sub-vectors of the latent vector based on the dequantized codeword index. The vector quantization block 630 may reconstruct the latent vector based on the reconstructed sub-vectors.

The entropy coder block 640 may receive a codeword index from the vector quantization block 630 and may compress the codeword index on a bit basis. The entropy coder block 640 may output a bitstream of a predetermined length (e.g. a variable length) based on the compressed codeword index.

The entropy decoder block 650 may decode the variable-length bitstream received from the entropy coder block 640. The entropy decoder block 650 may restore the codeword index based on the decoded bitstream. The entropy decoder block 650 may output the restored codeword index to the vector quantization block 630. The vector quantization block 630 may dequantize the codeword index and may reconstruct a latent vector including restored sub-vectors based on a dequantization result.

The decoder block 670 may receive the reconstructed latent vector from the vector quantization block 630. The decoder block 670 may reconstruct CSI based on the reconstructed latent vector. The decoder block 670 may output the reconstructed CSI.

As such, the autoencoder 600 of the present disclosure may quantize a latent vector representing CSI and may generate a variable-length bitstream from the quantized latent vector through entropy coding. Accordingly, the terminal may transmit CSI feedback including the variable-length bitstream generated through the autoencoder 600 to the base station, thereby reducing overhead of CSI feedback while preventing information loss in the CSI.

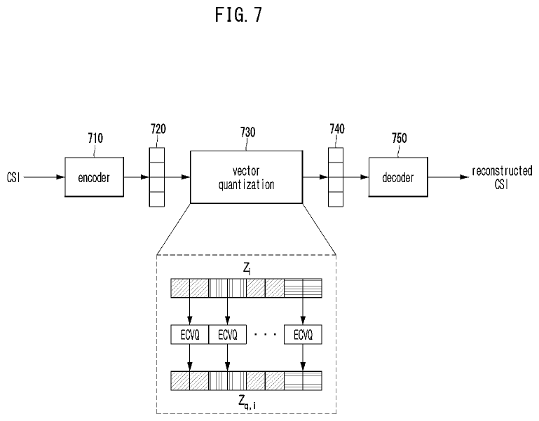

FIG. 7 is a conceptual diagram illustrating an exemplary embodiment of a training method for an autoencoder.

Referring to FIG. 7, an autoencoder may perform training for CSI feedback between a terminal and a base station. An encoder block 710, a vector quantization block 730, and a decoder block 750 of the autoencoder may jointly perform a training process for CSI feedback. However, the entropy coder block 640 and the entropy decoder block 650 of the autoencoder illustrated in FIG. 6 may assume lossless coding and decoding and may omit a training process for CSI feedback. An encoder latent space 720 illustrated in FIG. 7 may be an output space of the encoder block 710, and a decoder latent space 740 may be an input space of the decoder block 750.

The encoder block 710 may be trained to receive and compress CSI and to output a latent vector according to a compression result. The vector quantization block 730 may be trained to quantize the latent vector received from the encoder block 710 and to output the quantized latent vector according to the quantization result (e.g. codeword index). In addition, the vector quantization block 730 may be trained to dequantize the codeword index and to output a reconstructed latent vector. The decoder block 750 may be trained to reconstruct the latent vector output from the vector quantization block 730 and to reconstruct CSI.

The vector quantization block 730 may include at least one codebook, and each codebook may include a plurality of codewords. Each of the plurality of codewords may be represented as a fixed-dimensional vector. The vector quantization block 730 may perform training for quantization of a latent vector received from the encoder block 710 based on the at least one codebook. For example, the vector quantization block 730 may divide the latent vector into a plurality of sub-vectors. The vector quantization block 730 may map each of the plurality of sub-vectors of the latent vector to a corresponding codeword based on the codebook. The vector quantization block 730 may rearrange the mapped codewords in the order of the sub-vectors to generate a quantized latent vector. The vector quantization block 730 may output a codeword index (i.e. codeword index set) corresponding to the quantized latent vector. In addition, the vector quantization block 730 may perform training for dequantization of the quantized latent vector based on the codebook. For example, the vector quantization block 730 may select corresponding codewords from the codebook based on the codeword index and may reconstruct the latent vector based on the selected codewords.

The autoencoder may perform inference for a CSI feedback function using the trained encoder block 710, the trained vector quantization block 730, and the trained decoder block 750. In this case, the autoencoder may apply entropy coding or entropy decoding in an inference process. For example, the autoencoder may generate a latent vector for CSI through the trained encoder block 710 and may quantize the latent vector through the trained vector quantization block 730 to generate a codeword index for the quantized latent vector. The autoencoder may entropy-code the codeword index to generate a bitstream having a variable length and may output the bitstream as CSI feedback information. In addition, the autoencoder may entropy-decode the CSI feedback information, that is, the variable-length bitstream, to restore the codeword index and may dequantize the codeword index through the trained vector quantization block 730 to reconstruct the latent vector. The autoencoder may reconstruct CSI from the reconstructed latent vector through the trained decoder block 750.

As described above, each of the terminal and the base station may include an identical autoencoder. Accordingly, training of the autoencoder for CSI feedback may be performed in at least one of the terminal and the base station. For example, the autoencoder of the terminal may jointly train the encoder block 710, the vector quantization block 730, and the decoder block 750 for CSI feedback. The terminal may transmit at least one parameter based on a training result of the autoencoder to the base station. The base station may update parameters for the autoencoder of the base station based on the at least one parameter received from the terminal.

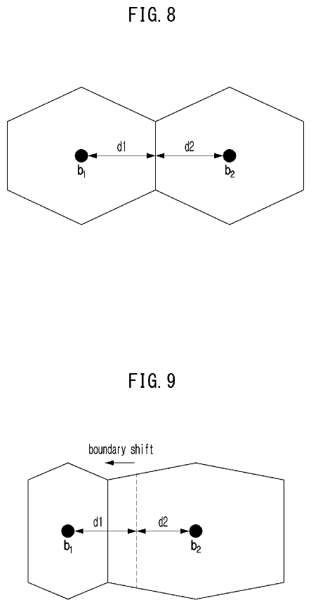

FIG. 8 is a conceptual diagram illustrating an exemplary embodiment of a method for setting a vector quantization criterion for training an autoencoder.

Referring to FIG. 7 and FIG. 8, the vector quantization block 730 of the autoencoder may apply a minimum Euclidean-distance criterion to determine a codeword corresponding to each sub-vector of a latent vector among a plurality of codewords of a codebook. For example, the vector quantization block 730 may select, among the plurality of codewords of the codebook, a codeword having a minimum distance from each sub-vector and may perform quantization to map each sub-vector to the selected codeword. Sub-vector quantization based on the minimum Euclidean-distance may be expressed as Equation 3 below.

$${z}_{q , i} = arg {min}_{{b}_{k} ∈ ℬ} {‖ {z}_{i} - {b}_{k} ‖}^{2} \qquad [ Equation 3 ]$$

Here, [symbol] may denote a codebook, zᵢ may denote an i-th sub-vector of a latent vector z, and bₖ may denote one of the plurality of codewords.

As such, the vector quantization block 730 may quantize each sub-vector considering the distance between each sub-vector of the latent vector and the plurality of codewords. Accordingly, as illustrated in FIG. 8, when a distance d1 between an i-th sub-vector zᵢ and a first codeword b₁ and a distance d2 between the i-th sub-vector zᵢ and a second codeword b₂ are identical, thereby forming a quantization boundary is formed, the vector quantization block 730 may select one of the first codeword b₁ and the second codeword b₂ as a quantized codeword for the i-th sub-vector zᵢ. However, since Euclidean distance-based quantization does not consider rate-distortion, compression efficiency may decrease when the codeword index generated by the quantization result of the vector quantization block 730 is entropy-coded.

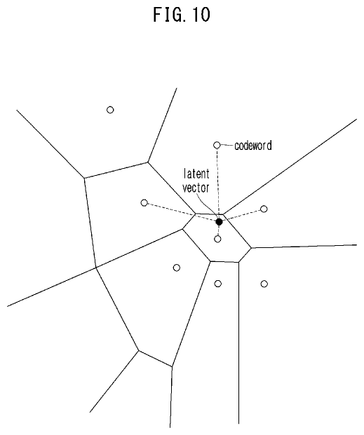

FIG. 9 is a conceptual diagram illustrating an exemplary embodiment of a method for setting a vector quantization criterion for training an autoencoder.

Referring to FIG. 7 and FIG. 9, the vector quantization block 730 of the autoencoder may consider optimization of bit length (or number of bits) together with Euclidean distance to determine a codeword for quantizing a latent vector. For example, the vector quantization block 730 may determine a codeword for each sub-vector based on a distance between each sub-vector of the latent vector and a plurality of codewords of a codebook and based on a prior probability distribution of each of the plurality of codewords. Quantization based on a distance between a sub-vector and codewords and based on prior probability may be expressed as Equation 4 below.

$${z}_{q , i} = arg {min}_{{b}_{k} ∈ ℬ} - {log}_{2} {P}_{k} + λ {‖ {z}_{i} - {b}_{k} ‖}^{2} \qquad [ Equation 4 ]$$

Here, [symbol] may denote a codebook, Pₖ may denote a prior probability that a codeword is selected, λ may denote a parameter controlling a trade-off between quantization quality and a bit length, zᵢ may denote an i-th sub-vector of a latent vector z, and bₖ may denote one of the plurality of codewords.

As such, the vector quantization block 730 may adaptively quantize each sub-vector considering the prior probability distribution of the plurality of codewords. As illustrated in FIG. 9, when a selection probability of the second codeword b₂ is higher among the first codeword b₁ and the second codeword b₂ for the i-th sub-vector zᵢ, an existing quantization boundary may be adjusted to move toward the first codeword b₁. Based on movement of the quantization boundary, when the i-th sub-vector zᵢ is located at the same distance from the first codeword b₁ and the second codeword b₂ (i.e. d1=d2), the vector quantization block 730 may select the second codeword b₂ having a higher prior probability as a quantization codeword for the i-th sub-vector zᵢ. Accordingly, the vector quantization block 730 may perform stable quantization for the i-th sub-vector zi based on probability and may improve compression efficiency, such as by reducing code length when entropy coding is performed.

Referring to FIG. 7, the autoencoder may define a loss function for training encoder block 710, the vector quantization block 730, and the decoder block 750 as Equation 5 below.

$${ℒ}_{vq} = {‖ \hat{H} - {\tilde{H}}_{ad} ‖}_{F}^{2} + {‖ sg ( z ) - {z}_{q} ‖}^{2} + β ‖ z - sg ( {z}_{q} ) {‖}^{2} \qquad [ Equation 5 ]$$

Here, Ĥ may denote reconstructed CSI, \tilde{H}_{ad} may node actual CSI, z may denote a latent vector, z_{q} may denote a quantized latent vector, sg(.) may denote a stop-gradient operator, and β may denote a weight parameter.

In Equation 5, the first term may indicate a loss associated with CSI reconstructed in the decoder block 750, the second term may indicate a codebook update loss of the vector quantization block 730, and the third term may indicate a loss of the latent vector output from the encoder block 710. A quantization loss of the vector quantization block 730 may be determined based on the second term and the third term of Equation 5. In addition, a latent vector quantization process of the vector quantization block 730 may have a discrete characteristic, and backpropagation for the quantization loss may not be propagated to the encoder block 710. Accordingly, the autoencoder may perform gradient correction on an input of the decoder block 750, that is, the latent vector, and may propagate a backpropagation gradient blocked in the quantization process to the encoder block 710.

Meanwhile, the loss function of the autoencoder determined according to Equation 5 mainly considers a reconstruction error and ensuring stability of the vector quantization process, and has limitations in directly minimizing a bit length or a number of bits required when the quantized latent vector is entropy-coded and transmitted. In other words, with the loss function defined in Equation 5, it may be difficult to induce a statistical distribution of the quantized latent vector (e.g. codeword index) output from the vector quantization block 730 toward a distribution with high entropy coding efficiency. Accordingly, the autoencoder may define, as Equation 6 below, a loss function reflecting minimization of bit length in order to reduce the entropy-coded feedback rate.

$${ℒ}_{ecvq} = {ℒ}_{vq} - \frac{( 1 + β )}{λ} {𝔼}_{k \vert z} [ {log}_{2} {P}_{k \vert z} ] \qquad [ Equation 6 ]$$

Here, [symbol] _{vq} may denote an existing loss function, λ may denote a parameter controlling a trade-off between quantization quality and bit length, β may denote a weight parameter, P_{k|z} may denote a probability that a latent vector z selects a codeword bₖ, and [symbol] _{k|z} may denote a weighted average for P_{k|z}.

The loss function shown in Equation 6 may be defined to simultaneously consider distortion generated in the quantization process of the vector quantization block 730 and a bit length required for entropy coding of the quantized latent vector. In other words, the first term of Equation 6 may indicate distortion corresponding to a quantization loss corresponding to a difference between the latent vector output from the encoder block 710 and the codebook of the vector quantization block 730. In addition, the second term of Equation 6 may be a term calculated based on a prior probability for the quantized latent vector and may indicate a bit length required for entropy coding. Accordingly, the autoencoder may simultaneously achieve vector quantization considering an entropy constraint and improvement of feedback efficiency based on the loss function of Equation 6.

Meanwhile, the autoencoder may perform training based on the loss function simultaneously considering quantization distortion and a bit length condition, and the codeword index for the quantized latent vector generated in the trained vector quantization block 730 may be converted into a variable-length bitstream in the entropy coding process. In this case, an entropy coding result may result in a larger bit amount than expected in a specific channel matrix or a specific feedback situation, and, due to the increase, the entropy coding result may exceed a maximum feedback budget allowed in the communication network. Accordingly, a maximum bit budget constraint for entropy coding of the codeword index may be required.

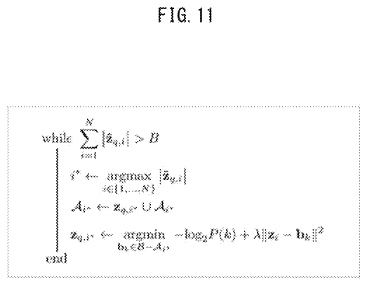

FIG. 10 is a conceptual diagram illustrating an exemplary embodiment of a method for applying a maximum feedback bit budget constraint of an autoencoder, and FIG. 11 is a conceptual diagram illustrating an exemplary embodiment of an algorithm for a maximum feedback bit budget constraint.

Referring to FIG. 6 and FIG. 10, the autoencoder 600 may jointly train the encoder block 610, the vector quantization block 630, and the decoder block 670 for a CSI feedback function. After the training stage is completed, the autoencoder 600 may perform an inference operation of the CSI feedback function for an actual operating environment, which includes the entropy coder block 640 and the entropy decoder block 650.

In the inference operation of the autoencoder 600, the entropy coder block 640 may entropy-code a codeword index output from the vector quantization block 630 to generate a variable-length bitstream. The autoencoder 600 may perform bit clipping so that the length of the coded bitstream does not exceed a maximum feedback bit budget.

As illustrated in FIG. 10, the vector quantization block 630 of the autoencoder 600 may divide a latent vector output from the encoder block 610 into a plurality of sub-vectors. The vector quantization block 630 may calculate distances between each divided sub-vector and a plurality of codewords of a codebook and may perform quantization to map each sub-vector to a closest codeword based on the calculated distances. The vector quantization block 630 may rearrange codewords mapped to each sub-vector according to the order of the sub-vectors and may output a codeword index including a plurality of indexes corresponding to the rearranged codewords. The entropy coder block 640 may entropy-code the codeword index received from the vector quantization block 630 and may output a variable-length bitstream for the codeword index.

For example, the vector quantization block 630 may divide the latent vector into four sub-vectors and may output a codeword index {3, 6, 2, 1} corresponding to codewords selected from a codebook for each sub-vector. The codeword index may include an index corresponding to each codeword. The entropy coder block 640 may entropy-code the codeword index to generate a bitstream having a variable length. Here, when a maximum bit budget for CSI feedback is set to 10 bits, if a total bit length (or a total number of bits) of the bitstream output from the entropy coder block 640 is 12 bits, the bitstream may exceed an allowable maximum bit budget or a maximum bit length limit. The autoencoder 600 may perform a bit clipping operation to adjust a bit length of the bitstream generated by entropy coding. For example, the autoencoder 600 may identify, among the plurality of indexes {3, 6, 2, 1} of the codeword index, an index causing the excess bit length, for example, an index {6}. The autoencoder 600 may replace the identified index with another index in the codebook having a smaller bit length, for example, an index {4}. The entropy coder block 640 may entropy-code again a codeword index {3, 4, 2, 1} configured to include the replaced index, and a bitstream according to a coding result may satisfy the maximum bit budget. The bit clipping operation of the autoencoder 600 may be performed based on an algorithm illustrated in FIG. 11.

As described above, the autoencoder 600 may reduce the bit length of the entropy-coded bitstream through bit clipping that replaces codeword indexes without performing a separate training process. However, in the process of replacing the codeword indexes, the autoencoder 600 may fail to use the optimal codeword indexes that should have originally been selected, thereby causing performance degradation. In particular, when the bit length of the entropy-coded bitstream greatly exceeds a preset maximum bit budget B, the autoencoder 600 may need to modify many indexes in order to reduce the length of the coded bitstream to be equal to or less than the maximum bit budget through bit clipping, which may further aggravate performance degradation.

Accordingly, the autoencoder 600 may determine whether to perform bit clipping on the entropy-coded bitstream by applying an allowable bit margin B_marg. For example, the autoencoder 600 may perform the bit clipping operation when the bit length B_c of the coded bitstream is less than or equal to a sum of the maximum bit budget B and the bit margin B_marg (i.e. B_c≤B+B_marg). In addition, when the bit length B_c of the coded bitstream is greater than the sum of the maximum bit budget B and the bit margin B_marg (i.e. B_c>B+B_marg), the autoencoder 600 may not perform the bit clipping operation.

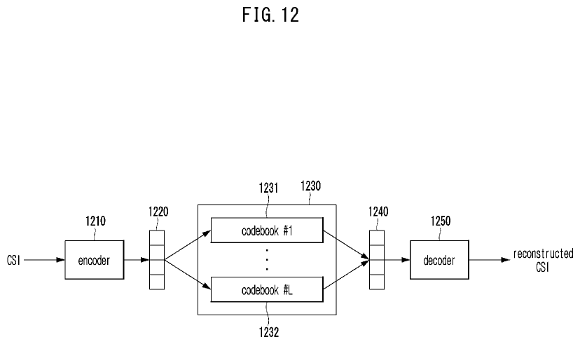

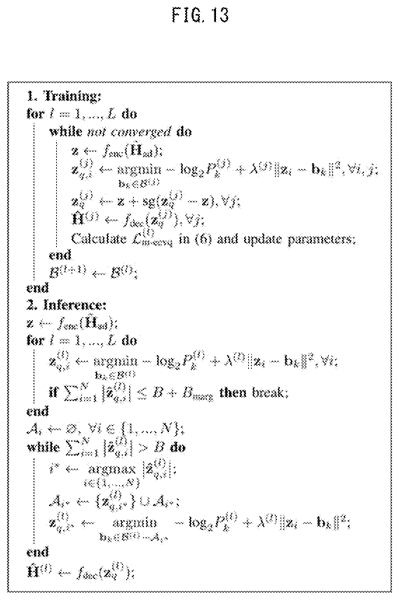

FIG. 12 is a conceptual diagram illustrating an exemplary embodiment of a method for satisfying a maximum feedback bit budget constraint of an autoencoder, and FIG. 13 is a conceptual diagram illustrating an exemplary embodiment of an algorithm for training and inference operations for satisfying a maximum feedback bit budget constraint of an autoencoder.

Referring to FIG. 12, an autoencoder may be trained such that an entropy-coded bitstream satisfies a maximum bit budget constraint during a training process of an encoder block 1210, a vector quantization block 1230, and a decoder block 1250. An encoder latent space 1220 illustrated in FIG. 12 may correspond to an output space of the encoder block 1210, and a decoder latent space 1240 may correspond to an input space of the decoder block 1250.

The vector quantization block 1230 of the autoencoder may include a plurality of codebooks 1231 and 1232 having different codeword distributions, and during the training process, may select one codebook satisfying the maximum bit budget constraint from among the plurality of codebooks 1231 and 1232.

Each of the plurality of codebooks 1231 and 1232 may be assigned different parameters (e.g. parameters (i.e. λ⁽¹⁾, . . . , λ^{(L)}) controlling a trade-off between quantization quality and bit length). Based on the assigned parameters (i.e. λ⁽¹⁾, . . . , λ^{(L)}), each of the plurality of codebooks 1231 and 1232 may have different feedback overhead levels, that is, different bit lengths required for transmission of the entropy-coded bitstream. The vector quantization block 1230 of the autoencoder may perform training using each of the plurality of codebooks 1231 and 1232 to which different parameters are assigned. In the codebook training process of the vector quantization block 1230, a quantization criterion of the l-th codebook may be represented as shown in Equation 7 below.

$${z}_{q , i}^{( l )} = {argmin}_{{b}_{k} ∈ {ℬ}^{( l )}} - {log}_{2} {P}_{k}^{( l )} + {λ}^{( l )} {‖ {z}_{i} - {b}_{k} ‖}^{2} \qquad [ Equation 7 ]$$

Here, [symbol] may denote a codebook, Pₖ may denote a prior probability that a codeword bₖ is selected, λ may denote a parameter controlling a trade-off between quantization quality and bit length, zᵢ may denote an i-th subvector of the latent vector z, and bₖ may denote one of the plurality of codewords.

The vector quantization block 1230 may sequentially train the plurality of codebooks 1231 and 1232. For example, when training a l-th codebook 1232, the vector quantization block 1230 may initialize the l-th codebook 1232 using parameters of the (l−1)-th codebook trained in a previous stage. Since the vector quantization block 1230 has already learned quantization of the latent vector to some extent through the (l−1)-th codebook, the training stability and convergence speed may be improved by initializing the l-th codebook 1232 using the learned information.

The vector quantization block 1230 may jointly train the plurality of codebooks 1231 and 1232 based on a loss function defined in Equation 8 below. For example, the vector quantization block 1230 may be trained such that a latent vector output from the encoder block 1210 is represented by a codeword of the closest codebook among the plurality of codebooks 1231 and 1232. The vector quantization block 1230 may optimize each of the plurality of codebooks 1231 and 1232 so that a distance (e.g. reconstruction error) between the latent vector and a codeword of the codebook is minimized.

$${ℒ}_{m - ecvq}^{( l )} = \frac{1}{{\sum }_{k = 1}^{l} {γ}^{k}} {\sum }_{j = 1}^{l} {γ}^{j} {ℒ}_{ecvq}^{( j )} \qquad [ Equation 8 ]$$

$${ℒ}_{ecvq}^{( j )} = {ℒ}_{vq}^{( j )} - \frac{( 1 + β )}{{γ}^{( j )}} {𝔼}_{k \vert z} [ {log}_{2} {P}_{k \vert z}^{( j )} ]$$

$${ℒ}_{vq}^{( j )} = {‖ {\hat{H}}^{( j )} - {\tilde{H}}_{ad} ‖}_{F}^{2} + {‖ sg ( z ) - {z}_{q}^{( j )} ‖}^{2} + β ‖ z - sg ( {z}_{q}^{( j )} ) {‖}^{2}$$

Here, γ may denote a parameter of a loss weight for each codebook, λ may denote a parameter controlling a trade-off between quantization quality and bit length, β may denote a weight parameter, P_{k|z} may denote a probability that a latent vector z selects a codeword bₖ, [symbol] _{k|z}[log₂ P_{k|z}] may denote a weighted average of P_{k|z}, Ĥ may denote reconstructed CSI, \tilde{H}_{ad} may denote actual CSI, z may denote the latent vector, z_{q} may denote a quantized latent vector, and sg(.) may denote a stop-gradient operator.

The vector quantization block 1230 may determine whether a total bit requirement of each of the plurality of codebooks 1231 and 1232 satisfies a preset maximum bit budget constraint. When the total bit requirement of each of the plurality of codebooks 1231 and 1232 satisfies the maximum bit budget, the vector quantization block 1230 may select a codebook having the smallest bit requirement among the plurality of codebooks 1231 and 1232. The vector quantization block 1230 may quantize a latent vector received from the encoder block 1210 using the selected codebook and may generate a codeword index (i.e. codeword index set) including indexes of codewords corresponding to the quantization result. For example, when the maximum bit budget constraint is 10 bits and the plurality of codebooks 1231 and 1232 have bit requirements of {4, 8, 12}, respectively, the vector quantization block 1230 may select a codebook having the smallest bit requirement (e.g. {4}) among the plurality of codebooks 1231 and 1232. The vector quantization block 1230 may quantize the latent vector using the selected codebook and output the codeword index for the quantized latent vector. In the above-described manner, the vector quantization block 1230 may select a codebook satisfying the maximum bit budget among the plurality of codebooks and quantize the latent vector. Accordingly, a bitstream generated by entropy-coding the quantized latent vector, that is, the codeword indexes, may satisfy the maximum bit budget constraint. The above-described training and inference operations of the autoencoder may be performed using an algorithm illustrated in FIG. 13.

Meanwhile, a situation may occur in which the vector quantization block 1230 fails to select a codebook satisfying the maximum bit budget constraint among the plurality of codebooks 1231 and 1232. In this case, the vector quantization block 1230 may select a codebook requiring a minimum number of bits among the plurality of codebooks 1231 and 1232 and output codeword indexes for the latent vector using the selected codebook. The autoencoder may generate a bitstream by entropy-coding the codeword indexes output from the vector quantization block 1230 and may determine whether to perform bit clipping on the entropy-coded bitstream as described with reference to FIGS. 10 and 11. The autoencoder may additionally perform a bit clipping operation on the codeword indexes according to the determination result.

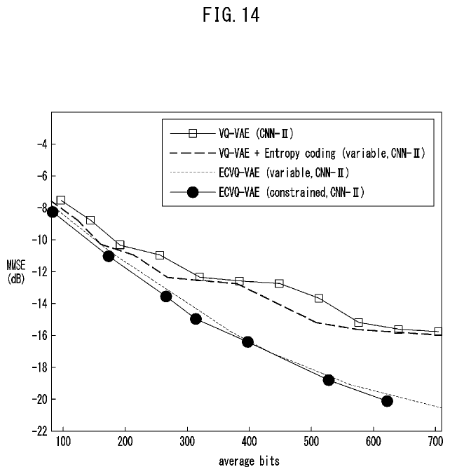

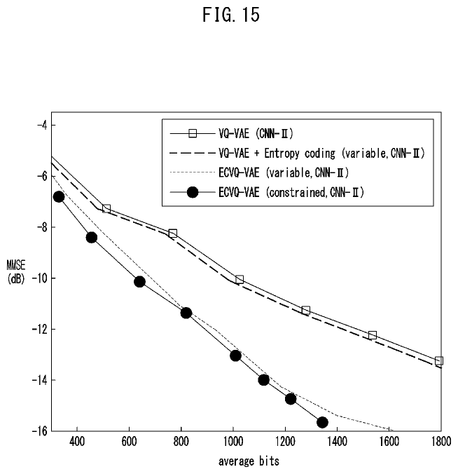

FIG. 14 is a graph showing performance of a CSI feedback function of a terminal in an indoor environment, and FIG. 15 is a graph showing performance of a CSI feedback function of a terminal in an outdoor environment.

Referring to FIGS. 14 and 15, a terminal of the present disclosure may transmit, to a base station, an entropy coding result that satisfies the maximum bit budget constraint using a pre-trained autoencoder. The autoencoder may be an entropy-constrained vector quantized variational autoencoder (ECVQ-VAE).

Accordingly, the present disclosure may achieve the lowest normalized mean square error (NMSE) under the same average bit condition compared with conventional CSI feedback schemes using vector-quantized variational autoencoder (VQ-VAE), thereby minimizing reconstruction error for CSI feedback and providing the best reconstruction fidelity.

The operations of the method according to the exemplary embodiment of the present disclosure can be implemented as a computer readable program or code in a computer readable recording medium. The computer readable recording medium may include all kinds of recording apparatus for storing data which can be read by a computer system. Furthermore, the computer readable recording medium may store and execute programs or codes which can be distributed in computer systems connected through a network and read through computers in a distributed manner.

The computer readable recording medium may include a hardware apparatus which is specifically configured to store and execute a program command, such as a ROM, RAM or flash memory. The program command may include not only machine language codes created by a compiler, but also high-level language codes which can be executed by a computer using an interpreter.

Although some aspects of the present disclosure have been described in the context of the apparatus, the aspects may indicate the corresponding descriptions according to the method, and the blocks or apparatus may correspond to the steps of the method or the features of the steps. Similarly, the aspects described in the context of the method may be expressed as the features of the corresponding blocks or items or the corresponding apparatus. Some or all of the steps of the method may be executed by (or using) a hardware apparatus such as a microprocessor, a programmable computer or an electronic circuit. In some embodiments, one or more of the most important steps of the method may be executed by such an apparatus.

In some exemplary embodiments, a programmable logic device such as a field-programmable gate array may be used to perform some or all of functions of the methods described herein. In some exemplary embodiments, the field-programmable gate array may be operated with a microprocessor to perform one of the methods described herein. In general, the methods are preferably performed by a certain hardware device.

The description of the disclosure is merely exemplary in nature and, thus, variations that do not depart from the substance of the disclosure are intended to be within the scope of the disclosure. Such variations are not to be regarded as a departure from the spirit and scope of the disclosure. Thus, it will be understood by those of ordinary skill in the art that various changes in form and details may be made without departing from the spirit and scope as defined by the following claims.

What is claimed is:

1. A method of a terminal, comprising:
generating channel state information (CSI) based on at least one channel state information-reference signal (CSI-RS) received from a base station;
compressing the CSI using a machine learning-based CSI encoder to generate a latent vector;
quantizing the latent vector based on at least one codebook to output a codeword index set;
entropy-coding the codeword index set to generate a variable-length bitstream; and
transmitting, to the base station, a CSI feedback including the variable-length bitstream.

2. The method of claim 1,
wherein the quantizing of the latent vector comprises:
dividing the latent vector into a plurality of sub-vectors;
mapping each of the plurality of sub-vectors to one of a plurality of codewords of the at least one codebook; and
rearranging the mapped codewords to output the codeword index set.

3. The method of claim 2,
wherein the mapping of each of the plurality of sub-vectors to one of the plurality of codewords comprises:
selecting codewords respectively corresponding to the plurality of sub-vectors based on at least one of a minimum Euclidean distance between each of the plurality of sub-vectors and the plurality of codewords or a prior probability distribution of each of the plurality of codewords; and
mapping the plurality of sub-vectors to the selected codewords, respectively.

4. The method of claim 1, further comprising:
adjusting a bit length of the variable-length bitstream based on a preset maximum bit budget.

5. The method of claim 4,
wherein the adjusting of the bit length of the variable-length bitstream comprises:
in response to determining that the bit length of the variable-length bitstream exceeds the preset maximum bit budget, performing bit clipping to replace at least one index having a largest bit length among a plurality of indexes included in the codeword index set with another index having a smaller bit length; and
entropy-coding a codeword index set reconstructed based on the bit clipping.

6. The method of claim 5,
wherein the adjusting of the bit length of the variable-length bitstream further comprises:
setting a bit margin; and
in response to determining that the bit length of the variable-length bitstream is greater than or equal to the preset maximum bit budget and less than or equal to a sum of the preset maximum bit budget and the bit margin, determining to perform the bit clipping.

7. The method of claim 6,
wherein the adjusting of the bit length of the variable-length bitstream further comprises:
in response to determining that the bit length of the variable-length bitstream is less than the preset maximum bit budget or exceeds the sum of the preset maximum bit budget and the bit margin, determining not to perform the bit clipping.

8. The method of claim 1,
wherein the quantizing of the latent vector comprises:
determining a total bit requirement of each of a plurality of codebooks;
selecting, from among some of the plurality of codebooks whose total bit requirements are less than or equal to a maximum bit budget, a codebook having a smallest bit requirement; and
quantizing the latent vector based on the selected codebook.

9. The method of claim 1,
wherein the quantizing of the latent vector comprises:
selecting a codebook having a smallest bit requirement among a plurality of codebooks, based on a total bit requirement of each of the plurality of codebooks exceeding a maximum bit budget;
quantizing the latent vector based on the selected codebook to output the codeword index set; and
performing bit clipping such that a bit length of the variable-length bitstream generated based on the codeword index set satisfies the maximum bit budget.

10. A method of a base station, comprising:
transmitting, to a terminal, at least one channel state information-reference signal (CSI-RS);
receiving, from the terminal, a CSI feedback including a bitstream generated based on the CSI-RS;
entropy-decoding the bitstream using a machine learning-based CSI decoder to restore a codeword index set;
dequantizing the codeword index set based on at least one codebook;
reconstructing a latent vector based on the dequantized codeword index set; and
restoring CSI from the reconstructed latent vector.

11. The method of claim 10,
wherein the dequantizing of the codeword index set comprises:
obtaining, from among a plurality of codewords of each of the at least one codebook, codewords corresponding to a plurality of indexes included in the codeword index set; and
rearranging the obtained codewords to generate the latent vector.

12. A terminal comprising: at least one processor, wherein the at least one processor causes the terminal to perform:
generating channel state information (CSI) based on at least one channel state information-reference signal (CSI-RS) received from a base station;
compressing the CSI using a machine learning-based CSI encoder to generate a latent vector;
quantizing the latent vector based on at least one codebook to output a codeword index set;
entropy-coding the codeword index set to generate a variable-length bitstream; and
transmitting, to the base station, a CSI feedback including the variable-length bitstream.

13. The terminal of claim 12, wherein in the quantizing of the latent vector, the at least one processor further causes the terminal to perform:
dividing the latent vector into a plurality of sub-vectors;
mapping each of the plurality of sub-vectors to one of a plurality of codewords of the at least one codebook; and
rearranging the mapped codewords to output the codeword index set.

14. The terminal of claim 13, where in the mapping of each of the plurality of sub-vectors to one of the plurality of codewords, the at least one processor further causes the terminal to perform:
selecting codewords respectively corresponding to the plurality of sub-vectors based on at least one of a minimum Euclidean distance between each of the plurality of sub-vectors and the plurality of codewords or a prior probability distribution of each of the plurality of codewords; and
mapping the plurality of sub-vectors to the selected codewords, respectively.

15. The terminal of claim 12, wherein the at least one processor further causes the terminal to perform: adjusting a bit length of the variable-length bitstream based on a preset maximum bit budget.

16. The terminal of claim 15, wherein in the adjusting of the bit length of the variable-length bitstream, the at least one processor further causes the terminal to perform:
in response to determining that the bit length of the variable-length bitstream exceeds the preset maximum bit budget, performing bit clipping to replace at least one index having a largest bit length among a plurality of indexes included in the codeword index set with another index having a smaller bit length; and
entropy-coding a codeword index set reconstructed based on the bit clipping.

17. The terminal of claim 16, wherein in the adjusting of the bit length of the variable-length bitstream, the at least one processor further causes the terminal to perform:
setting a bit margin; and
in response to determining that the bit length of the variable-length bitstream is greater than or equal to the preset maximum bit budget and less than or equal to a sum of the preset maximum bit budget and the bit margin, determining to perform the bit clipping.

18. The terminal of claim 17, wherein in the adjusting of the bit length of the variable-length bitstream, the at least one processor further causes the terminal to perform: in response to determining that the bit length of the variable-length bitstream is less than the preset maximum bit budget or exceeds the sum of the preset maximum bit budget and the bit margin, determining not to perform the bit clipping.

19. The terminal of claim 12, wherein in the quantizing of the latent vector, the at least one processor further causes the terminal to perform:
determining a total bit requirement of each of a plurality of codebooks;
selecting, from among some of the plurality of codebooks whose total bit requirements are less than or equal to a maximum bit budget, a codebook having a smallest bit requirement; and
quantizing the latent vector based on the selected codebook.

20. The terminal of claim 12, where in the quantizing of the latent vector, the at least one processor further causes the terminal to perform:
selecting a codebook having a smallest bit requirement among a plurality of codebooks, based on a total bit requirement of each of the plurality of codebooks exceeding a maximum bit budget;
quantizing the latent vector based on the selected codebook to output the codeword index set; and
performing bit clipping such that a bit length of the variable-length bitstream generated based on the codeword index set satisfies the maximum bit budget.
